(19) United States
(12) Patent Application Publication
(10) Pub. No.: US 2024/0208010 A1
(43) Pub. Date: Jun. 27, 2024

(54) Adjustable Wrench

(71) Applicant: Robert Bosch GmbH, Stuffgart (DE)

(72) Inventor: Dan Newkirk, Owatonna, MN (US)

(21) Appl. No.: 18/388,619

(22) Filed: Nov. 10, 2023

Related U.S. Application Data
(60) Provisional application No. 63/434,680, filed on Dec. 22, 2022.

(51) Int. Cl. B25B 13/12

(52) U.S. Cl. CPC B25B 13/12

(57) ABSTRACT

A wrench having a carriage slot of an adjustable size, suitable for accommodating and interacting with a range of nuts of different sizes. The size of the carriage slot is controlled by an adjustment mechanism that controls the position of a slider within the carriage slot. The position of the slider may be controlled by rotating a handle of the wrench.

### TECHNICAL FIELD

This disclosure relates to shop tools, and in particular hand-operated tools.

### BACKGROUND

Modern wrenches are typically designed to either accommodate a particular size of nut, or to be adjustable but accommodating of a variety of nuts having different shapes. Implementations that provide exact fitting for a particular size are most efficient in use of the wrench but are not suitable to be used with any other size of nut. Adjustable wrenches are suitable for use with a variety of sizes but can provide sub-optimal torque because of poor fit with the nut. Additionally, adjustable wrenches may not be useable at in some conditions because the adjustment mechanism increases the overall size of the wrench head, limiting their utility in small spaces.

What is desired is an adjustable wrench that can be utilized in the same conditions as size-specific wrenches, that further provides similar torque as the size-specific wrench.

### SUMMARY

One aspect of this disclosure is directed to a wrench comprising a head with a carriage slot, a slider disposed within the carriage slot, and a handle extending from the head. The handle defines an axis, and the wrench further comprises an adjustment mechanism to move the slider within the carriage slot along the axis. The slider moves with respect to a static side of the carriage slot, and the slider and the static side form a pair of grips to interface with nuts of different dimensions. In some embodiments, the adjustment mechanism comprises a knob, such as a knurled knob. In some embodiments, the slider is coupled directly to the handle.

The above aspects of this disclosure and other aspects will be explained in greater detail below with reference to the attached drawings.

### BRIEF DESCRIPTION OF THE DRAWINGS

FIG. 1 is an illustration of an adjustable wrench.

FIG. 2 is an exploded view of the adjustable wrench of FIG. 1.

FIG. 3 is an illustration of the adjustable wrench of FIG. 1 from a different perspective.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

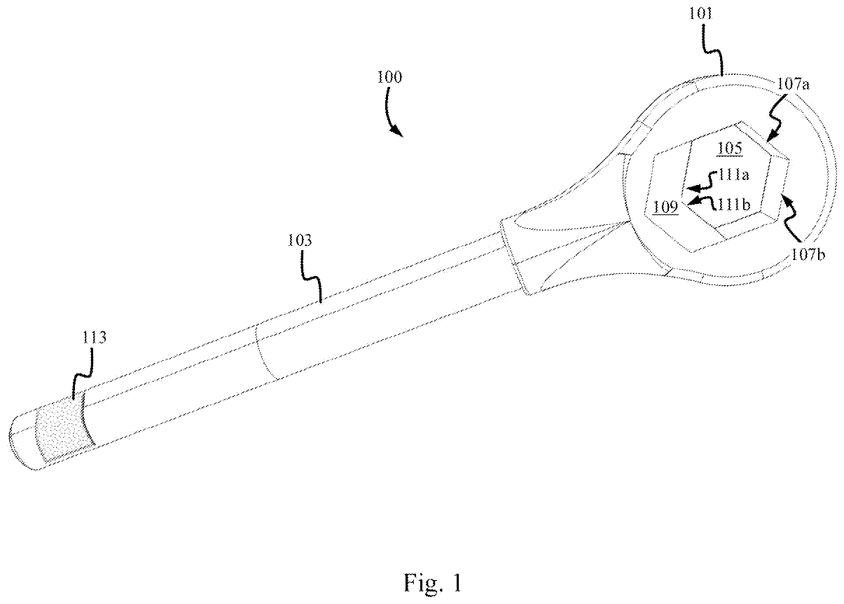

FIG. 1 is an illustration of an adjustable wrench 100 according to one embodiment of the instant invention. Wrench 100 comprises a head 101 and a handle 103. Head 101 defines within it a carriage slot 105 suitable to interface with a nut of at least a first size. Carriage slot 105 is defined by a number of sides, including at least one static side 107 and at least one side defined by a slider 109, depicted herein as slider side 111.

In the depicted embodiment, the sides of carriage slot 105 form a hexagonal shape suitable to interface with hexagonal nuts, but other embodiments may comprise other limitations without deviating from the teachings disclosed herein. By way of example, and not limitation, the sides of carriage slot 105 may comprise a curved surface forming an elliptical shape, straight surfaces forming a parallelogram shape, angled surfaces forming an octagonal shape, angled surfaces forming a star shape, or any other shape recognized by one of ordinary skill in the art suitable to interface with a nut of a known shape without deviating from the teachings disclosed herein.

In the depicted embodiment, carriage slot 105 comprises two static sides 107a and 107b joined at an angle, but other embodiments may comprise a different number of sides or a different angle without deviating from the teachings disclosed herein. In the depicted embodiment, the slider 109 comprises two slider sides 111a and 111b joined at an angle inverse to the angle formed by static sides 107a and 107b, but other embodiments may comprise a different number of sides or a different angle without deviating from the teachings disclosed herein. In the depicted embodiment, the angles formed within carriage slot 105 between any two sides comprise a 120-degree angle such that carriage slot 105 conforms to a regular hexagonal shape, but other embodiments may comprise different angles forming different shapes without deviating from the teachings disclosed herein. The exact angles formed within carriage slot 105 may be exact within a specified tolerance, such as within +2 degrees, without deviating from the teachings disclosed herein. Different embodiments may comprise different specified tolerances without deviating from the teachings disclosed herein.

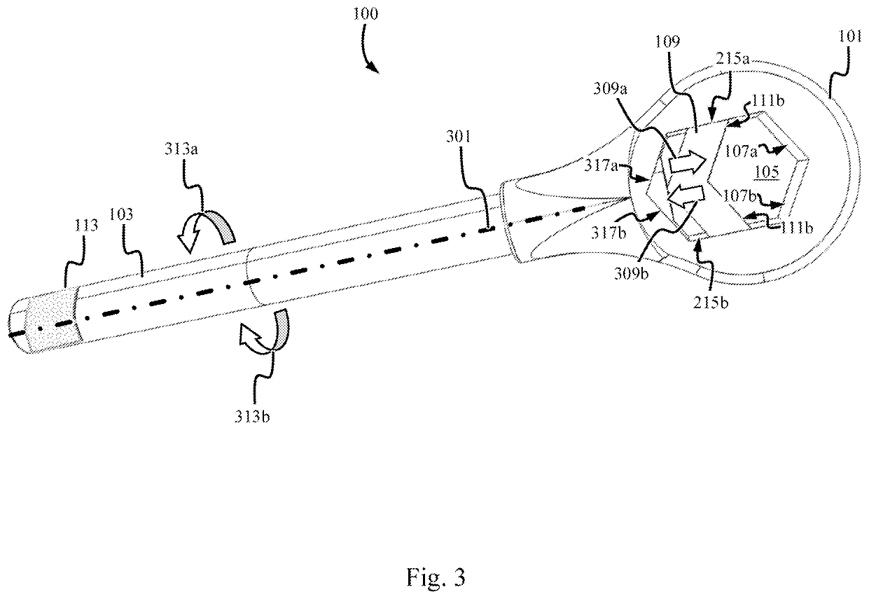

In the depicted embodiment, handle 103 comprises a knurled surface 113 to optimize a user's grip when using adjustable wrench 100. In the depicted embodiment, knurled surface 113 is additionally raised compared to the surface of the rest of handle 103, creating a knob surface for a user to grip and turn handle 103 with respect to head 101. This feature will be discussed with additional detail in later portions with respect to FIG. 3.

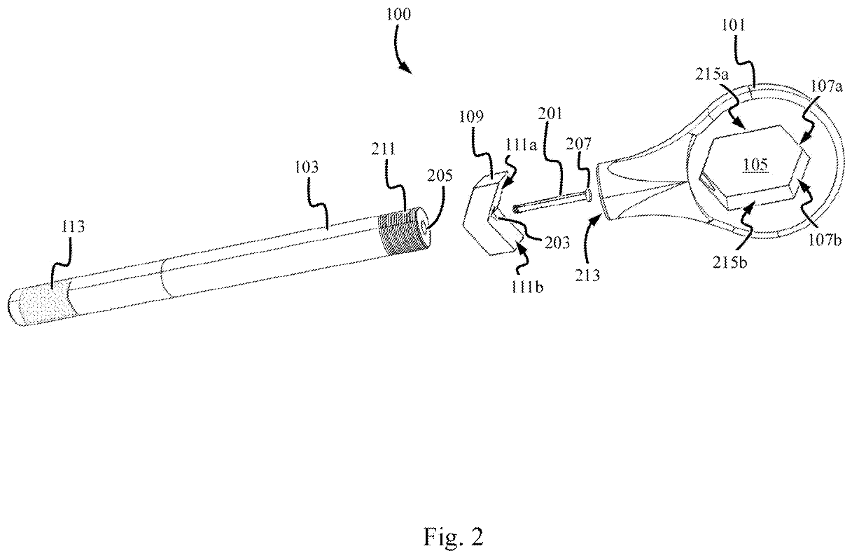

FIG. 2 depicts wrench 100 in an exploded-view to better illustrate additional features. In this depiction, it is observable that slider 109 is retained in position with respect to handle 103 via a retaining pin 201. Retaining pin 201 is threaded through a slider channel 203 of slider 109 and received by the handle using a retaining socket 205. In the depicted embodiment, retaining pin 201 comprises a threaded end that is received by matching threads within retaining socket 205, but other embodiments may comprise other configurations without deviating from the teachings disclosed herein. In the depicted embodiment, slider 109 is retained by retaining pin 201 via a cap-end 207 of retaining pin 201. Cap-end 207 is wider in diameter than portions of slider channel 205, but other embodiments may comprise other configurations to retain slider 109 without deviating from the teachings disclosed herein. Handle 103 additionally comprises handle threads 211 that are configured to be received and interface with receiving threads 213 inside a receiving end of head 101. This interface of handle threads 211 and receiving threads 213 both maintains the assembly of wrench 100, but also permits the adjustment of the position of slider 109 during use. In the depicted embodiment, arrangement of slider 109 with respect to handle 103 is maintained by retaining pin 201, and adjustment of the handle threads 211 with respect to the receiving threads 213 directly adjusts the position of handle 103 with respect to head 101, and thus indirectly adjusts the position of slider 109 within carriage slot 105.

These elements, when working in combination, provide an adjustment mechanism for wrench 100, and in particular for slider 109 with respect to static sides 107, which will be described in further detail with respect to FIG. 3. In the depicted embodiment, slider 109 is mounted loosely with retaining pin 201, in such a manner that it would normally rotate about an axis formed by retaining pin 201. However, slider 109 is sized based upon the dimensions of carriage slot 105, and additional sides of carriage slot 105 prevent rotation of slider 109 because of the precision fit of the components. These sides are indicated in FIG. 2 as retention sides 215. In some uses of wrench 100 retention sides are intended to interface directly with one or more sides of a nut during use, but in other instances the retention sides may not be directly interfacing with a nut without deviating from the teachings disclosed herein.

FIG. 3 provides an additional view of wrench 100 in its assembled state and illustrates functional features of wrench 100. In particular, it is illustrated in FIG. 3 that handle 103 additionally defines an axis 301 along which slider 109 is configured to move during operation of the adjustment mechanism. When the adjustment mechanism is utilized, it has the effective result of adjusting the open space defining carriage slot 105. Because the open space of carriage slot 105 receives a nut intended to be adjusted by the wrench 100, adjusting the size thereof effectively changes the size of a nut that may be adjusted by wrench 100. When slider 109 is moved in a first direction 309a, the open area of carriage slot 105 shrinks, a smaller length of retention sides 215 remain operable, and a smaller nut is suitable to be adjusted by wrench 100. In contrast, when slider 109 is moved in a second direction 309b, the open area of carriage slot 105 grows as a longer length of retention sides 215 are made operable, and a larger nut is suitable to be adjusted by wrench 100. Carriage slot 105 achieves its maximal size when slider 109 is in a first positioned and retained by outer carriage perimeter sides 317 and slider 109 can no longer move in direction 309b along axis 301. Carriage slot 105 achieves its minimal size when slider 109 is in a second position forming an angle with the static sides 107 and can no longer move in direction 309a along axis 301. Placement of slider 109 at intermediary positions between the first position and the second position will result in accommodation of nuts of different corresponding sizes.

Motion of slider 309 is achieved by rotation handle 103 about axis 301. In the depicted embodiment, rotating handle 103 about axis 301 in direction 313a is suitable to adjust the position of slider 109 along axis 301 in direction 309a. In the depicted embodiment, rotating handle 103 about axis 301 in direction 313b is suitable to adjust the position of slider 109 along axis 301 in direction 309b. Other embodiments may comprise other adjustment mechanism configurations without deviating from the teachings disclosed herein.

In the depicted embodiment, carriage slot 105 comprises a hexagonal shape, but other embodiments may comprise other shapes without deviating from the teachings disclosed herein. When the carriage slot 105 is opened to its maximal size, all of sides 107, 111, and 215 will interact with an appropriately sized nut during operation. For operable use with smaller nuts, slider 109 may be positioned about the nut in place, and a smaller number of sides may directly engage with the nut during tightening/loosening. By way of example, and not limitation, smaller hexagonal nuts may directly engage only with static sides 107 and slider sides 111 without deviating from the teachings disclosed herein. Advantageously, this interaction with a fewer number of sides of the carriage slot 105 is still sufficient because smaller nuts require less directed force to rotate under normal operating circumstances. For this reason, the maximum size of carriage slot 105 dictates the range of nut sizes that are suitable for use with wrench 100.

The dimensions of the components of wrench 100 additionally dictate what sizes and designs of nuts are compatible. In the depicted embodiment, carriage slot 105 forms a hexagonal shape, wherein all the angles thereof are 120-degree angles, but other embodiments may comprise other configurations without deviating from the teachings disclosed herein. In the depicted embodiment, the maximal size of carriage slot 105 is suitable to accommodate a 3.5-inch hexagonal nut, and the minimal size of carriage slot 105 is suitable to accommodate a 1-inch hexagonal nut. Other embodiments may comprise other ranges of compatible nuts without deviating from the teachings disclosed herein. Handle 103 may nominally be in the range of 16-22 inches in length, but other embodiments may comprise other lengths to accommodate other nut sizes as known to one of ordinary skill in the art. In the depicted embodiment, handle 103 is 18 inches in length, but other configurations do not deviate from the teachings disclosed herein. In the depicted embodiment, all components of wrench 100 may be comprised of forged steel alloy, but other embodiments may comprise different materials, such as iron, aluminum, stainless steel, resin, a polymer, carbon fiber, or a composite material without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A wrench comprising:
a head with a carriage slot having a static side, the carriage slot suitable for interfacing with a nut;
a slider disposed within the carriage slot;
a handle extending from the head, the handle defining an axis; and
an adjustment mechanism suitable to move the slider within the carriage slot along the axis relative to the static side.

2. The wrench of claim 1, wherein the adjustment mechanism comprises a threaded end of the handle that engages a corresponding thread of an inner surface of the head.

3. The wrench of claim 2, wherein the handle comprises a knob.

4. The wrench of claim 1, wherein the slider is coupled directly to the handle.

5. The wrench of claim 1, wherein the slider is movable between a first position and a second position, the first position corresponding to a maximum size of the carriage slot, and the second position corresponding to a minimum size of the carriage slot.

6. The wrench of claim 5, wherein the maximum size of the carriage slot accommodates a 3.5-inch hexagonal nut.

7. The wrench of claim 5, wherein the minimum size of the carriage slot accommodates a 1-inch hexagonal nut.

8. The wrench of claim 1, wherein the handle has a length between 16-22 inches.

9. The wrench of claim 1, wherein the handle has a knurled surface.

10. The wrench of claim 1, wherein the static side comprises two segments forming a first angle.

11. The wrench of claim 10, wherein the slider comprises two segments forming a second angle that is the inverse of the first angle.

12. The wrench of claim 10, wherein the first angle is a 120-degree angle.
